(19) United States
(12) Patent Application Publication
(10) Pub. No.: US 2014/0300910 A1
(43) Pub. Date: Oct. 9, 2014

(54) IMAGE FORMING SYSTEM, IMAGE FORMING METHOD, AND RECORDING MEDIUM

(71) Applicant: Sharp Kabushiki Kaisha, Osaka (JP)

(72) Inventor: Masato Tokishige, Osaka (JP)

(73) Assignee: SHARP KABUSHIKI KAISHA, Osaka (JP)

(21) Appl. No.: 14/230,299

(22) Filed: Mar. 31, 2014

(30) Foreign Application Priority Data
Apr. 3, 2013 (JP) 2013-077990

(51) Int. Cl. G06Q 30/04; G06K 15/02

(52) U.S. Cl. CPC G06Q 30/04; G06K 15/021
USPC 358/1.6

(57) ABSTRACT

Disclosed is an image forming system including an image forming apparatus which includes an image forming section receiving an instruction to perform an image forming job on a recording sheet and a billing apparatus forming an image of billing information on a specific recording sheet depending on the job. The image forming system determines whether the image of the billing information from the billing apparatus may be formed, when an instruction relating to the image forming job is received, and if it is determined that the image of the billing information may not be formed, allows the image forming section to form the image of the billing information on the recording sheet depending on a job relating to the received instruction.

### CROSS-REFERENCE TO RELATED APPLICATIONS

This Nonprovisional application claims priority under 35 U.S.C. §119(a) on Patent Application No. 2013-77990 filed in Japan on Apr. 3, 2013, the entire contents of which are hereby incorporated by reference.

### BACKGROUND

1. Technical Field

The present invention relates to an image forming system which includes an image forming apparatus including an image forming section receiving an instruction to perform an image forming job on a recording sheet and a billing apparatus forming an image of billing information on a specific recording sheet depending on the job and an image forming method in the image forming system.

2. Description of the Related Art

Recently, public facilities, convenience stores, or the like, are provided with an image forming apparatus such as a printer or a multifunction peripheral and a user may pay a prescribed charge to use the image forming apparatus. Further, a billing apparatus installed along with the image forming apparatus collects a usage fee and issues a receipt on which billing information such as a usage fee and detailed of usage fee is printed.

For example, Japanese Patent Laid-Open Publication No. 2009-239465 discloses an image forming apparatus connected to a billing apparatus outputting an acknowledgement, in which since the image forming apparatus receives a selection on whether the acknowledgement is output from a user before the user inputs a setting condition, such a situation that the user remembers a need of issuing the acknowledgement after the image forming apparatus has ended the provision of a service may be eliminated.

### SUMMARY

There may be a case in which the above-mentioned image forming apparatus is connected to an external server, in which data for issuing a local government certification, or the like are stored, to provide a service which acquires data relating to a basic resident registration card from the server and issues a certificate of residence.

However, in order for the image forming apparatus to provide the service, the image forming apparatus has to issue a receipt every time the certificate of residence is issued, and therefore, for example, there is a problem in that a series of jobs including such an issuance of the certificate of residence may not be performed when the receipt may not be issued for any reason. However, the image forming apparatus related to Patent Document 1 may not solve the problem.

In consideration of the above-mentioned circumstances, it is an object of the present invention to provide an image forming system including an image forming apparatus which includes an image forming section receiving an instruction to perform an image forming job on a recording sheet and a billing apparatus forming an image of billing information on a specific recording sheet depending on the job, wherein the image forming system is configured to determine whether an image of the billing information from the billing apparatus may be formed, when the instruction relating to the image forming job is received, and allow the image forming section to form the image of the billing information on the recording sheet depending on job related to the received instruction, if it is determined that the image of the billing information may not be formed, and thereby it is possible to perform the image forming job which essentially issues a receipt (the billing information) even when the receipt may not be printed due to a shortage of a dedicated recording sheet and the like.

Another object of the present invention is to provide an image forming method in the image forming system.

In order to achieve the above objects, according to an aspect of the present invention, there is provided an image forming system including an image forming apparatus which includes an image forming section receiving an instruction to perform an image forming job on a recording sheet and a billing apparatus forming an image of billing information on a specific recording sheet depending on the job, the image forming system including: a availability determination section configured to determine whether the image of the billing information is to be formed, when an instruction relating to the image forming job is received; and an instruction section configured to instruct the image forming section to form the image of the billing information depending on a job relating to the received instruction, if the availability determination section determines that the image of the billing information is not to be formed, wherein when the instruction from the instruction section is received, the image forming section forms the image of the billing information on the recording sheet.

In the image forming system according to the present invention, a primary job which requires the formation of the image of the billing information and a secondary job which does not require the formation of the image of the billing information are selectively performed, at the time of performing the primary job, if the availability determination section determines that the image of the billing information is not to be formed, the image forming section forms the image of the billing information depending on the primary job, and at the time of performing the secondary job, if the availability determination section determines that the image of the billing information is not to be formed, the image forming section performs the secondary job but the image of the billing information depending on the secondary job is not formed.

In the image forming system according to the present invention, the image forming apparatus includes recording sheets having a plurality of types of sizes, the image forming apparatus includes a selection section configured to select a recording sheet having the smallest size among the plurality of types of sizes, if the availability determination section determines that the image of the billing information is not to be formed, and the image forming section forms the image of the billing information on the recording sheet selected by the selection section.

In the image forming system according to the present invention, the recording sheet has a rectangular shape, and the image forming section forms the image of the billing information on edges of the recording sheet.

According to another aspect of the present invention, there is provided an image forming method, for forming an image of billing information, in an image forming system including an image forming apparatus which includes an image forming section receiving an instruction to perform an image forming job on a recording sheet and a billing apparatus forming an image of billing information on a specific recording sheet depending on the job, the image forming method comprising: a step of determining whether the image of the billing information is to be formed, when an instruction relating to the image forming job is received, a step of instructing the image forming section to form the image of the billing information depending on job relating to the received instruction, if it is determined that the image of the billing information is not to be formed in the determining step, and a step of forming the image of the billing information on the recording sheet by the image forming section, when the instruction is received from the instructing step.

According to the present invention having the above configuration, the image forming system is configured to determine whether an image of the billing information from the billing apparatus may be formed, when the instruction relating to the image forming job is received, and allow the image forming section to form the image of the billing information on the recording sheet depending on job related to the received instruction, if it is determined that the image of the billing information may not be formed, thereby it is possible to perform the image forming job which essentially issues a receipt (the billing information) even when the receipt may not be printed due to a shortage of a dedicated recording sheet and the like.

The above and further objects and features will more fully be apparent from the following detailed description with accompanying drawings

### BRIEF DESCRIPTION OF THE SEVERAL VIEWS

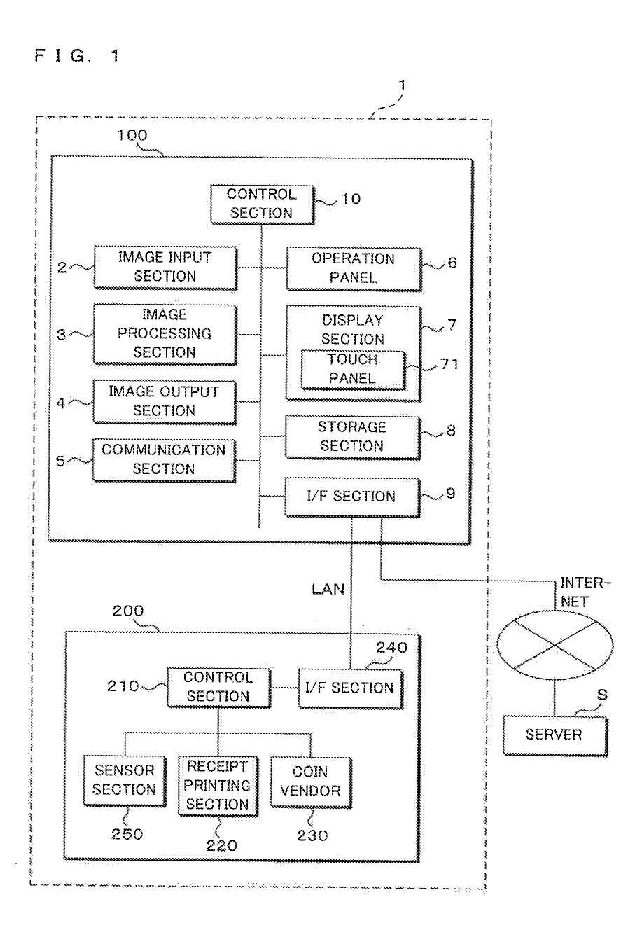

FIG. 1 is a functional block diagram illustrating a configuration of major parts of a multifunction peripheral and a billing apparatus, in an image forming system according to an embodiment of the present invention.

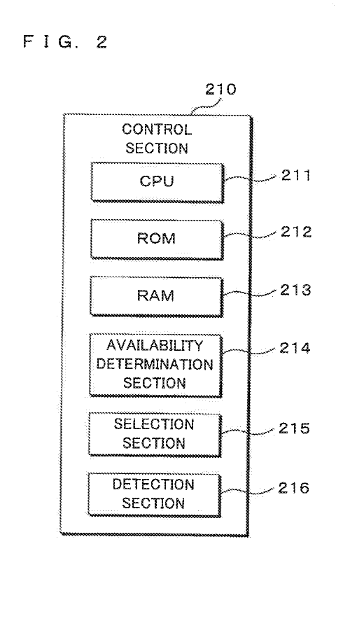

FIG. 2 is a functional block diagram illustrating a configuration of major parts of a control section in the billing apparatus according to the embodiment of the present invention.

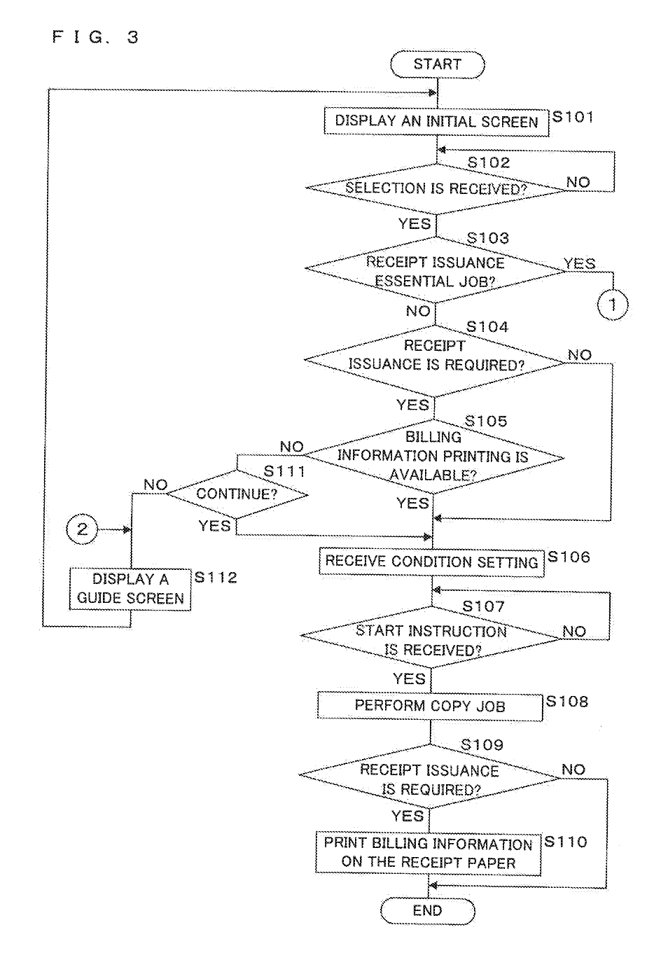

FIG. 3 is a flow chart for explaining processing of the multifunction peripheral and the billing apparatus in the image forming system according to an embodiment of the present invention.

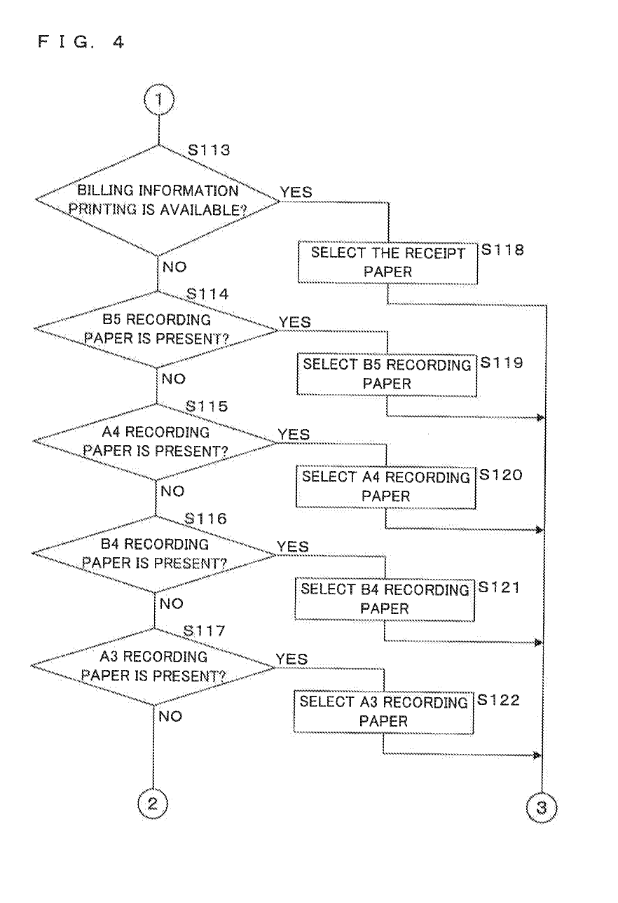

FIG. 4 is a flow chart for explaining the processing of the multifunction peripheral and the billing apparatus in the image forming system according to an embodiment of the present invention.

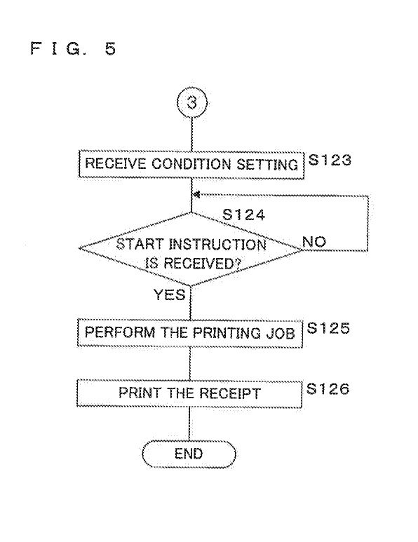

FIG. 5 is a flow chart for explaining the processing of the multifunction peripheral and the billing apparatus in the image forming system according to the embodiment of the present invention.

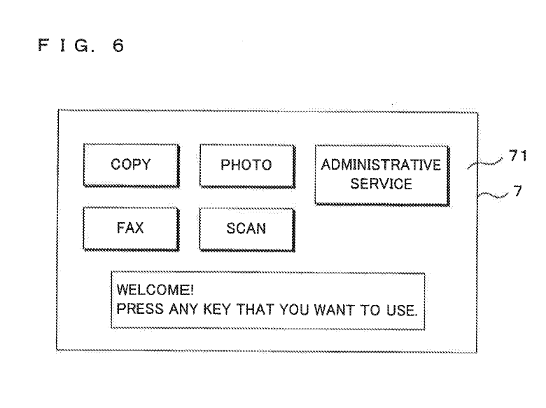

FIG. 6 is a schematic view illustrating an example of an initial screen displaying various types of services which may be provided by the multifunction peripheral in the image forming system according to the embodiment of the present invention.

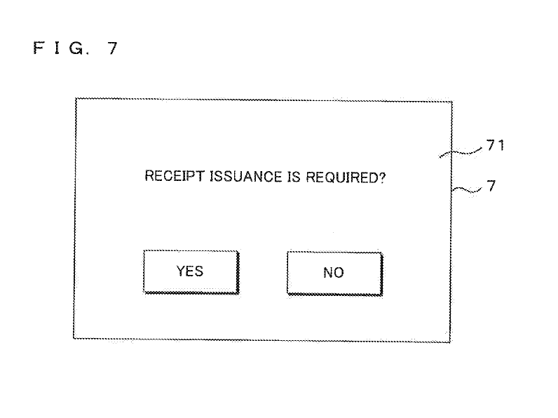

FIG. 7 is a schematic view illustrating an example of a guide screen querying whether a receipt issuance is required in the image forming system according to the embodiment of the present invention.

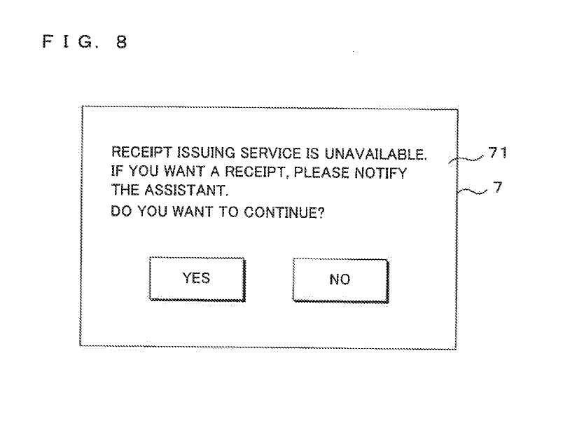

FIG. 8 is a schematic view illustrating an example of the guide screen querying whether to continue to perform a selected job in the image forming system according to the embodiment of the present invention.

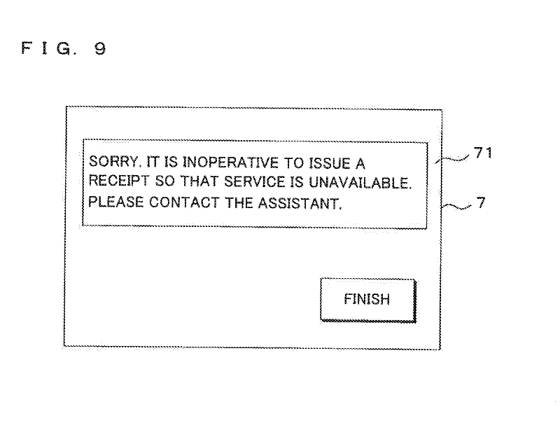

FIG. 9 is a schematic view illustrating an example of the guide screen notifying the fact that a service may not be provided since the receipt may not be issued in the image forming system according to the embodiment of the present invention.

### DETAILED DESCRIPTION

Hereinafter, an image forming apparatus according to an embodiment of the present invention is applied to a multifunction peripheral and an image forming system and an image forming method according to an embodiment of the present invention will be described in detail with reference to the accompanying drawings.

FIG. 1 is a functional block diagram illustrating a configuration of major parts of a multifunction peripheral and a billing apparatus, in an image forming system according to an embodiment of the present invention. An image forming system 1 according to the embodiment of the present invention includes a multifunction peripheral 100 and a billing apparatus 200 and is connected to an external server S via the Internet.

The server S is stored with, for example, data for issuing a local government certification and the image forming system 1 may provide a service which acquires data relating to a basic resident registration card from the server S via the Internet and issues a certificate of residence.

As described above, however, a job to issue the certificate of residence essentially involves a receipt issuance and therefore when the receipt may not be issued, the job may also not be performed. Hereinafter, the job, such as the issuance of the certificate of residence, which essentially involves the receipt issuance, is referred to as a receipt issuance essential job.

The multifunction peripheral 100 includes hardware, such as a control section 10, an image input section 2, an image processing section 3, an image output section 4, a communication section 5, an operation panel 6, a display section, a storage section 8, and an I/F section 9, and generally configures a digital multifunction peripheral.

The image input section 2 optically reads an image data of a manuscript. Further, the image input section 2 includes an optical unit which includes a light source irradiating light to the manuscript for reading, an image sensor such as a charge coupled device (CCD) and the like. Further, the image input section 2 forms an optical image reflected from the manuscript set at a prescribed read position on an image sensor and outputs an analog electrical signal of red-green-blue (RGB). The analog electrical signal output from the image input section 2 is input to the image processing section 3.

The image processing section 3 generates digital type image data based on the analog electrical signal input through the image input section 2 or reads an image data stored in the storage section 8 performs processing depending on each type of images and then generates an image data for outputting. Further, the image processing section 3 generates image data relating to the certificate of residence based on a data of a basic resident registration card acquired from the server S via the Internet.

The image output section 4 forms an image on a recording sheet, such as recording paper and an OHP film, based on the image data output from the image processing section 3 and outputs the formed image. For this reason, the image output section 4 includes a photoreceptor drum, a charger which charges the photoreceptor drum with a prescribed potential, a laser writing device which emits a laser beam depending on the image data received from the outside to generate an electrostatic latent image on the photoreceptor drum, a developer which supplies a toner to the electrostatic latent image formed on a surface of the photoreceptor drum and develops the image, a transcriber (not illustrated) which transcribes a toner image formed on the surface of the photoreceptor drum onto a paper, and forms an image desired by a user on a sheet by an electro-photographic method. Further, in addition to forming the image by the electro-photographic method using the laser writing device, the image may be formed by an inkjet method, a thermal transfer method, a sublimation method or the like.

The communication section 5 includes a network card, a modem, and the like which transmits image data processed by the image processing section 3 to the outside and transmits, for example, the image data attached to an e-mail to a set designation. Further, the communication section 5 acquires the data of the basic resident registration card from the server S via the Internet.

The operation panel 6 includes functional buttons, such as ‘copy’ and ‘printing’, a numeric pad, an enter key establishing the received instruction, and the like, which are related to important functions of the multifunction peripheral 100.

The storage section 8 includes, for example, a non-volatile storage memory, such as a flash memory, an EEPROM, an HDD, a magneto-resistive memory (MRAM), a ferroelectric RAM (FeRAM), or an OUM. The storage section 8 stores, for example, information (hereinafter, information on recording paper) which is related to the recording papers stored in each tray included therein. An example of the information on the recording paper may include the presence or absence of B5 recording paper, the presence or absence of A4 recording paper, the presence or absence of B4 recording paper and the like.

The display section 7 includes, for example, an LCD, an electroluminescence (EL) panel, or the like and displays an image to be output (printed) on the prescribed recording paper through the image output section 4. Further, the display section 7 displays information to be notified to the user, such as a state of the multifunction peripheral 100, a job processing situation, an image of a manuscript read by the image input section 2, and a confirmation of an operation content of the operation panel 6 and the like.

Further, in the display section 7, a front of the display screen on which the image is displayed is provided with a touch panel 71. The touch panel 71 may detect a prescribed position on the display screen of the display section 7 by a touch operation of a user's finger tip. The touch panel 71 senses a change in pressure by the touch operation of the user's finger tip or senses an electrical signal by static electricity and detects coordinates on the display screen of the display section 7 corresponding to the touched position of the user's finger tip to generate a signal specifying the coordinates. Further, the touch panel 71 is not limited thereto and therefore may be configured to use a pointing device (for example, stylus pen) and the like.

The I/F section 9 is connected to, for example, the external server 8, a PC or the like. Further, the I/F section 9 is connected to the billing apparatus 200 through a LAN. For example, the control section 10 of the multifunction peripheral 100 receives an instruction from a control section 210 of the billing apparatus 200 through the I/F section 9.

The control section 10 appropriately controls each hardware described above to perform jobs relating to services to be provided to the user.

Further, the multifunction peripheral 100 includes a plurality of trays (not illustrated) in which the recording papers having a plurality of types of sizes are stored. For example, B5 recording paper, A4 recording paper, B4 recording paper, and A3 recording paper may be stored in the plurality of trays. Further, sensors which detect the shortage of the recording papers are installed in each tray and a selection section 215 of the billing apparatus 200 to be described below may determine the presence or absence of each recording paper depending on the detection results of the sensors and select the prescribed recording paper.

The billing apparatus 200 is connected to the multifunction peripheral 100 through the LAN and includes the control section 210, a sensor section 250, a receipt printing section 220, a coin vendor 230, and an I/F section 240.

The receipt printing section 220 includes, for example, a recording paper storage part (not illustrated) and a printing unit (not illustrated) having a so-called thermal head. Heat sensitive receipt paper wound in a roll shape is injected into the recording paper storage part and the billing information is printed on the receipt paper delivered from the recording paper storage part.

The billing information is information which is related to a fee to be collected from the user depending on the service provided from the multifunction peripheral 100 and a statement thereof. For example, when the issuance service of a certificate of residence is provided to the user, the billing information is information including the number of papers issued, a size of the recording paper, a usage fee, a received (input) amount of money, the change, and the like in the job of issuing the certificate of residence and is a so-called receipt or acknowledgement.

The sensor section 250 detects, for example, whether receipt paper is present in the recording paper storage part of the receipt printing section 220 and detects a temperature of the thermal head. A detection section 216 to be described below detects the shortage of the receipt paper, and the like, based on the detection result by the sensor section 250 and a availability determination section 214 to be described below determines whether the billing information may be printed.

The coin vendor 230 includes, for example, a coin injection slot and a coin return slot. The control section 210 calculates a change from the usage fee and the injected amount of money depending on a job performed when a coin is put into the coin injection slot, and returns a coin corresponding to the change to the user through the coin return slot.

The I/F section 240 is connected to the multifunction peripheral 100 through the LAN. For example, the control section 210 of the billing apparatus 200 issues an instruction to be described below to the control section 10 of the multifunction peripheral 100 through the I/F section 240.

The control section 210 controls the multifunction peripheral 100 through the LAN to receive the instruction relating to a prescribed job (a service) through the multifunction peripheral 100, performs the job on the multifunction peripheral 100 and issues the instructions which are related to the billing processing (calculation of the usage fee, calculation of the change, and the like) and the printing of the billing information depending on the job.

FIG. 2 is a functional block diagram illustrating a configuration of major parts of the control section 210 in the billing apparatus 200 according to the embodiment of the present invention. The control section 210 includes a CPU 211, a ROM 212, a RAM 213, an availability determination section 214, the selection section 215, and the detection section 216.

The ROM 212 is basically pre-stored with various control programs, fixed data among parameters for operation, and the like, and the RAM 213 temporarily stores data and reads the data independent of a storage order, a storage position or the like. Further, the RAM 213 stores, for example, programs read from the ROM 212, various data generated by running the programs, parameters appropriately changed at the time of running or the like.

The CPU 211 (an instruction section) operates the overall apparatus as the billing apparatus 200 according to the present invention to print the above-described billing processing (settlement of the usage fee, calculation of the balance, and the like) and the billing information and instructs the multifunction peripheral 100 to perform a job by loading and running the control program pre stored in the ROM 212 onto the RAM 213 to control various types of the above-described hardware.

The availability determination section 214 determines whether the receipt printing section 220 may print the billing information, when receiving the instructions relating to the image formation such as the selection of the job (the service) through the operation panel 6 of the multifunction peripheral 100, the setting of the condition relating to the performing of the job and the like. For example, the availability determination section 214 performs the determination based on the sensing results of the sensor section 250 or the detection result of the detection section 216.

For example, when the detection section 216 detects the shortage of the receipt paper or detects that the detection temperature of the thermal head is equal to or less than a prescribed threshold value, the availability determination section 214 determines that the billing information may not be printed.

The selection section 215 selects the recording paper on which the billing information is to be printed. The selection section 215 may select a prescribed recording paper based on the sensing result of the sensors of each tray of the multifunction peripheral 100 or the detection result of the detection section 216.

For example, when the availability determination section 214 determines that the billing information may be printed, the selection section 215 selects the receipt paper as the recording paper on which the billing information is printed. Meanwhile, when the availability determination section 214 determines that the billing information may not be printed, the selection section 215 selects a prescribed recording paper based on the information on the recording paper stored in the storage section 8 of the multifunction peripheral 100 and the sensing results of the sensors of each tray. In more detail, the selection section 215 selects the smallest recording paper among various sizes of recording papers which are actually provided in the multifunction peripheral 100, based on the information on the recording paper and the sensing results of the sensors of each tray.

The detection section 216 detects the shortage of the receipt paper, for example, based on the sensing result of the sensor section 250 or detects whether the detected temperature of the thermal head is the prescribed threshold value or less.

FIGS. 3 to 5 are flowcharts for explaining the processing of the multifunction peripheral 100 and the billing apparatus 200 in the image forming system 1 according to the embodiment of the present invention. For the convenience of explanation, the image forming system 1 may be placed in public places, such as a so-called convenience store and the multifunction peripheral 100 is configured to provide services relating to jobs (a secondary job) such as copying, printing photographs, and scanning, in addition to providing an issuance service of the certificate of residence (a primary job) as described above. Hereinafter, for the convenience of explanation, a service to issue the certificate of residence is referred to as an ‘administrative service’ and only an administrative service is defined as a receipt issuance essential job.

For example, when the user touches the display section 7 (the touch panel 71) of the waiting multifunction peripheral 100 or when the user appropriately operates the operation panel 6, the display section 7 displays an initial screen as illustrated in FIG. 6 (step S101). The initial screen of FIG. 6 displays various service items, which may be provided by the multifunction peripheral 100, as soft keys.

In this case, the CPU 211 of the billing apparatus 20( ) monitors the touch panel 71 of the multifunction peripheral 100 through the LAN and determines whether a job selection is received (step S102).

If it is determined that a job selection is not received (step S102: NO), the CPU 211 repeatedly performs the determination until a specific job selection is received.

Meanwhile, if it is determined that a job selection is received (step S102: YES), the CPU 211 determines whether the job relating to the received selection is a receipt issuance essential job (step S103).

When the CPU 211 determines that the job relating to the received selection is a receipt issuance essential job (step S103: YES), that is, the job relating to the received selection is an administrative service (the certificate of residence issuance service), the process proceeds to step S113.

Further, if it is determined that the job relating to the received selection is not a receipt issuance essential job (step S103: NO), the CPU 211 displays on the display section 7 a guide screen querying whether a receipt issuance is required. Hereinafter, for the convenience of explanation, a copying job is considered to be selected.

FIG. 7 is a schematic view illustrating an example of the guide screen querying whether a receipt issuance is required, in the image forming system 1 according to the embodiment of the present invention. The guide screen illustrated in FIG. 7 displays the soft keys of “YES” and “NO” for receiving an answer to the query and the user may select any one of the “YES” and “NO”.

Next, the CPU 211 monitors the touch panel 71 of the multifunction peripheral 100 to determine whether a receipt issuance is required (step S104). Further, the determination result by the CPU 211 is stored in the RAM 213.

When the user operates the soft key of “NO” on the guide screen of FIG. 7, the CPU 211 determines that the receipt issuance is not required (step S104: NO) and the process proceeds to step S106.

Meanwhile, when the user operates the soft keys of “YES” on the guide screen of FIG. 7, the CPU 211 determines that a receipt issuance is required (step S104: YES). In this case, the availability determination section 214 determines whether the receipt printing section 220 may print the billing information (step S105). The determination by the availability determination section 214 is performed based on the sensing result of the sensor section 250 or the detection result of the detection section 216. The determination is already described and therefore a detailed description thereof will be omitted.

If the availability determination section 214 determines that the receipt printing section 220 may print the billing information (step S105: YES), the process proceeds to step S106.

Meanwhile, if the availability determination section 214 determines that the receipt printing section 220 may not print the billing information (step S105: NO), the CPU 211 notifies the fact that the receipt may not be issued and displays a guide screen querying whether to continue to perform the selected job (copy) on the display section 7 of the multifunction peripheral 100.

FIG. 8 is a schematic view illustrating an example of the guide screen querying whether to continue to perform the selected job, in the image forming system 1 according to the embodiment of the present invention. The guide screen illustrated in FIG. 8 displays the soft keys of “YES” and “NO” for receiving an answer to the query and the user may select any one of the “YES” and “NO”.

Next, the CPU 211 monitors the touch panel 71 of the multifunction peripheral 100 and determines whether to continue to perform the selected job (step S111).

When the user performs the selection by operating the soft key of “YES” on the guide screen of FIG. 8, the CPU 211 receives the selection through the touch panel 71 and determines that the selected job is to continue to be performed (step S111: YES), the process proceeds to step S106.

Meanwhile, when the user performs the selection by operating the soft key of “NO” on the guide screen of FIG. 8, the CPU 211 receives the selection through the touch panel 71 and determines that the selected job is not to continue to be performed (step S111: NO).

In this case, the CPU 211 instructs the control section 10 of the multifunction peripheral 100 to display a guide screen notifying the fact that the service may not be provided since the receipt may not be issued on the display section 7 of the multifunction peripheral 100. The control section 10 of the multifunction peripheral 100 displays the guide screen as illustrated in FIG. 9 on the display section 7 depending on the instruction of the CPU 211 (step S112). Next, the process returns to step S101.

FIG. 9 is a schematic view illustrating an example of the guide screen notifying the fact that a service may not be provided since the receipt may not be issued, in the image forming system 1 according to the embodiment of the present invention. The guide screen illustrated in FIG. 9 displays a soft key of “END” to receive the confirmation of the user on the notification of the fact that the service may not be provided.

Meanwhile, in step S105, when the availability determination section 214 determines that the receipt printing section 220 may print the billing information (step S105: YES), or in step S111, when the CPU 211 continues to perform the selected job (step S111: YES), the display section 7 displays a reception screen for receiving a condition setting of the job.

According to the embodiment of the present invention, since the selected job is a copy, the user appropriately operates the reception screen (the touch panel 71) and sets conditions such as the number of sheets, magnification, and intensity. In this case, the CPU 211 receives the condition setting of the job through the reception screen (the touch panel 71) (step S106). The received condition setting is temporarily stored in the RAM 213.

In this case, the CPU 211 calculates the usage fee based on the received condition setting and displays the calculated usage fee on the display section 7. When the user puts a fee into the coin slot of the coin vendor 230, the CPU 211 determines whether a start instruction is received.

The CPU 211 monitors the operation panel 6 and the touch panel 71 of the multifunction peripheral 100 and determines whether the start instruction is received (step S107). When it is determined that the start instruction is not received (step S107: NO), the CPU 211 repeatedly performs the determination until it receives the start instruction.

Meanwhile, if it is determined that the start instruction is received (step S107: YES), the CPU 211 instructs the control section 10 of the multifunction peripheral 100 to perform a copy. Depending on the instruction of the CPU 211, the control section 10 of the multifunction peripheral 100 appropriately controls the image input section 2, the image processing section 3, and the image output section 4 and performs the copy job (step S108).

When the performing of the job is completed, the CPU 211 determines whether the printing of the receipt is required (step S109). The determination is performed by allowing the CPU 211 to confirm the determination result of the step S104 stored in the RAM 213.

If it was determined that the receipt is required in step S104, the CPU 211 determines that the printing of the receipt is required (step S109: YES) and instructs the receipt printing section 220 to print the billing information (the receipt). The receipt printing section 220 prints the billing information on the receipt paper depending on the instruction of the CPU 211 to print the receipt (step S110) and provide the printed receipt to the user.

Meanwhile, if it was determined that the receipt is unnecessary in step S104, the CPU 211 determines that the receipt is unnecessary (step S109: NO), and thus the process ends.

However, when the job relating to the selection received from the user is an administrative service (the certificate of residence issuance service), in step S103, the CPU 211 determines that the job relating to the received selection is a receipt issuance essential job (step S103: YES).

In this case, the availability determination section 214 determines whether the receipt printing section 220 may print the billing information (step S113). The determination by the availability determination section 214 is performed based on the sensing result of the sensor section 250 or the detection result of the detection section 216.

If the availability determination section 214 determines that the receipt printing section 220 may print the billing information (step S113: YES), the selection section 215 selects the receipt paper as the recording paper on which the billing information is printed (step S118). Next, the process proceeds to step S123.

For example, when the shortage of the receipt paper is detected by the detection section 216, the availability determination section 214 determines that the receipt printing section 220 may not print the billing information (step S113: NO) and the selection section 215 selects the smallest recording paper among various sizes of recording papers which are actually provided in the multifunction peripheral 100, based on the information for the recording paper stored in the storage section 8 and the sensing results of the sensors of each tray. Hereinafter, for the convenience of explanation, the multifunction peripheral 100 is assumed to may have B5, A4, B4, and A3 recording papers.

First, the selection section 215 determines whether the B5 recording paper is present in the tray corresponding to the B5 recording paper based on the sensing results of the sensors of each tray of the multifunction peripheral 100 (step S114). If it is determined that the B5 recording paper is present in the tray corresponding to the B5 recording paper (step S114: YES), the selection section 215 selects the B5 recording paper as the recording paper on which the billing information is printed (step S119). Next, the process proceeds to step S123.

Meanwhile, if it is determined that the B5 recording paper is absent in the tray corresponding to the B5 recording paper (step S114: NO), the selection section 215 determines whether the A4 recording paper is present in the tray corresponding to the A4 recording paper based on the sensing results of the sensors of each tray of the multifunction peripheral 100 (step S115).

If it is determined that the A4 recording paper is present in the tray corresponding to the A4 recording paper (step S115: YES), the selection section 215 selects the A4 recording paper as the recording paper on which the billing information is printed (step S120). Next, the process proceeds to step S123.

Further, if it is determined that the A4 recording paper is absent in the tray corresponding to the A4 recording paper (step S115: NO), the selection section 215 determines whether the B4 recording paper is present in the tray corresponding to the B4 recording paper based on the sensing results of the sensors of each tray of the multifunction peripheral 100 (step S116).

If it is determined that the B4 recording paper is present in the tray corresponding to the B4 recording paper (step S116: YES), the selection section 215 selects the B4 recording paper as the recording paper on which the billing information is printed (step S121). Next, the process proceeds to step S123.

Meanwhile, if it is determined that the B4 recording paper is absent in the tray corresponding to the B4 recording paper (step S116: NO), the selection section 215 determines whether the A3 recording paper is present in the tray corresponding to the A3 recording paper based on the sensing results of the sensors of each tray of the multifunction peripheral 100 (step S117).

If it is determined that the A3 recording paper is present in the tray corresponding to the A3 recording paper (step S117: YES), the selection section 215 selects the A3 recording paper as the recording paper on which the billing information is printed (step S122). Next, the process proceeds to step S123.

Further, if the selection section 215 determines that the A3 recording paper is absent in the tray corresponding to the A3 recording paper (step S117: NO), the process proceeds to step S112 to display a guide screen as illustrated in FIG. 9 on the display section 7 of the multifunction peripheral 100 (step S112) and then the process returns to step S101.

Meanwhile, as described above, in step S118, step S119, step S120, step S121, or step S122, when the recording paper on which the billing information is printed is selected, the CPU 211 receives the condition setting of the job through the reception screen (the touch panel 71) (step S123). According to the embodiment of the present invention, since the selected job is a copy, the user appropriately operates the reception screen (the touch panel 71) and sets conditions such as the number of sheets, magnification, and intensity. The received condition setting is temporarily stored in the RAM 213.

In this case, the CPU 211 calculates the usage fee based on the received condition setting and displays the calculated usage fee on the display section 7. When the user puts a fee into the coin slot of the coin vendor 230, the CPU 211 determines whether a start instruction is received.

The CPU 211 monitors the operation panel 6 and the touch panel 71 of the multifunction peripheral 100 and determines whether the start instruction is received (step S124). When it is determined that the start instruction is not received (step S124: NO), the CPU 211 repeatedly performs the determination until it receives the start instruction.

Meanwhile, if is determined that the start instruction is received (step S124: YES), the CPU 211 instructs the control section 10 of the multifunction peripheral 100 to perform the job. Depending on the instruction of the CPU 211, the control section 10 of the multifunction peripheral 100 appropriately controls the communication section 5, the image processing section 3, and the image output section 4 and performs the printing job (the administrative service) of the certificate of residence (step S125).

That is, depending on the instruction of the control section 10, the communication section 5 acquires the data of the basic resident registration card from the server S via the Internet, the image processing section 3 generates the image data relating to the certificate of residence based on the data of the basic resident registration card acquired from the server S, and the image output section 4 prints the certificate of residence based on the generated image data.

When the performing of the job is completed, the CPU 211 instructs the receipt printing section 220 or the multifunction peripheral 100 to print the billing information (the receipt) depending on the job of the administrative service, based on the selection of the recording paper in step S118, step S119, step S120, step S121, or step S122.

When the receipt paper is selected as the recording paper on which the billing information is printed, the receipt printing section 220 prints the billing information on the receipt paper depending on the instruction of the CPU 211 to print the receipt (step S126).

Further, when any one of the B5, A4, B4, and A3 recording papers is selected as the recording paper on which the billing information is printed, the image output section 4 of the multifunction peripheral 100 prints the billing information on one of the B5, A4, B4, and A3 recording papers to print the receipt (step S126). Next, the printed receipt is provided to the user and the process ends.

Further, in the image forming system 1 according to the embodiment of the present invention, when the image output section 4 of the multifunction peripheral 100 prints the billing information on one of the B5, A4, B4, and A3 recording papers, the printing is performed at edges of each paper having a rectangular shape. Therefore, the user simply removes the unnecessary portion and makes the recording paper the same shape as the receipt paper, thereby it is possible to prevent a waste of resources.

Further, the above-mentioned availability determination section 214, selection section 215, and detection section 216 may be built in hardware logic, but however, since the CPU 211 runs a prescribed program, they may also be built in software.

In the above description, the control section 210 of the billing apparatus 200 includes the availability determination section 214, the selection section 215 and the detection section 216, and the case in which the receipt issuance essential job is performed is described, but the present invention is not limited thereto. For example, a control section including the availability determination section 214, the selection section 215 and the detection section 216 may be provided separately from the multifunction peripheral 100 and the billing apparatus 200, or may be provided at the multifunction peripheral 100 side.

Further, in the above description, the case in which the processes from step S113 to step S126 are performed only for the receipt issuance essential job is described by way of example, but the present invention is not limited thereto. For example, in step S111, if it is determined that the process is not continued, the process may be configured to proceed to step S113. By this, in the case that it is not the receipt issuance essential job but the user strongly wants to issue the receipt, the present invent is able to respond to the shortage of the receipt paper.

In the present invention, the image forming system 1 includes an image forming apparatus 100 which includes an image forming section 4 receiving an instruction to perform the image forming job on the recording sheet and a billing apparatus 200 forming an image of billing information on a specific recording sheet depending on job, wherein the image forming system 1 is characterized by including: a availability determination section 214 configured to determine whether the image of the billing information is to be formed, when an instruction relating to the image forming job is received; and an instruction section 211 configured to instruct the image forming section 4 to form the image of the billing information depending on job relating to the received instruction, if the availability determination section 214 determines that the image of the billing information is not to be formed, and when the instruction from the instruction section 211 is received, the image forming section 4 forms the image of the billing information on the recording sheet.

According to the present invention having the above configuration, when the instruction relating to the image forming job is received, the image forming system determines whether the image of the billing information from the billing apparatus may be formed, and if it is determined that the image of the billing information may not be formed, allows the image forming section to form the image of the billing information on the recording sheet depending on job relating to the received instruction, thereby it is possible to perform the image forming job which essentially issues the receipt (the billing information) even when the receipt may not be printed due to a shortage of a dedicated recording sheet and the like.

In the present invention, the image forming system is characterized in that, a primary job which requires the formation of the image of the billing information and a secondary job which does not require the formation of the image of the billing information are selectively performed, at the time of performing the primary job, if the availability determination section determines that the image of the billing information is not to be formed, the image forming section 4 forms the image of the billing information depending on the primary job, and at the time of performing the secondary job, if the availability determination section determines that the image of the billing information is not to be formed, the image forming section performs the secondary job but the image of the billing information depending on the secondary job is not formed.

According to present invention having the above configuration, at the time of performing the primary job, if the availability determination section determines that the image of the billing information may not be formed, the instruction section instructs the image forming section to form the image of the billing information depending on primary job, such that the image forming section forms the image of the billing information depending on primary job. Further, at the time of performing the secondary job, if the availability determination section determines that the image of the billing information may not be formed, the instruction section allows the image forming section to perform the secondary job without formation of the image of the billing information depending on secondary job, such that the image forming section performs the secondary job without performing the image formation of the billing information depending on secondary job.

In the present invention, the image forming system is characterized in that, the image forming apparatus 100 includes recording sheets having a plurality of types of sizes, and includes a selection section 215 configured to select a recording sheet having the smallest size among the plurality of types of sizes, if the availability determination section 214 determines that the image of the billing information is not to be formed, and the image forming section 4 forms the image of the billing information on the recording sheet selected by the selection section 215.

According to the present invention having the above configuration, if the availability determination section determines that the billing apparatus may not form the image of the billing information, the selection section selects the recording sheet having the smallest size among the plurality of types of sizes, such that the image forming section performs the image formation of the billing information on the recording sheet selected by the selection section, thereby it is possible to prevent a waste of resources.

In the present invention, the image forming system is characterized in that, the recording sheet has a rectangular shape, and the image forming section 4 forms the image of the billing information on edges of the recording sheet.

According to the present invention having the above configuration, when the image of the billing information is formed on the recording sheet selected by the selection section, since the image forming section 4 forms the image of the billing information on the edges of the recording sheet, a user simply removes the unnecessary portion and therefore may make the recording sheet the same shape as the receipt paper, thereby it is possible to prevent a waste of resources.

In the present invention, the image forming method for forming an image of billing information, in an image forming system 1 including an image forming apparatus 100 which includes an image forming section 4 receiving an instruction to perform an image forming job on a recording sheet and a billing apparatus 200 forming an image of billing information on a specific recording sheet depending on job, wherein the image forming method is characterized by including: a propriety determining step 214 of determining whether the image of the billing information is to be formed, when an instruction relating to the image forming job is received; an instruction step 211 of instructing the image forming section 4 to form the image of the billing information depending on job relating to the received instruction, if it is determined that the image of the billing information is not to be formed in the propriety determining step 214; and a step of forming the image of the billing information on the recording sheet by the image forming section 4, when the instruction is received from the instruction step 211.

According to the present invention having the above configuration, when receiving the instruction relating to the image forming job from a user, it is determined whether the image of the billing information from the billing apparatus may be formed, and if it is determined that the billing information may not be formed, the image forming section receives the instruction to form the image of the billing information depending on job relating to the received instruction. When receiving the instruction, the image forming section forms the image of the billing information on the recording sheet, thereby it is possible to perform the image forming job which essentially issues the receipt (the billing information) even when the receipt may not be printed due to a shortage of a dedicated recording sheet and the like.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An image forming system including an image forming apparatus which includes an image forming section receiving an instruction to perform an image forming job on a recording sheet and a billing apparatus forming an image of billing information on a specific recording sheet depending on the job, the image forming system comprising:
an availability determination section configured to determine whether the image of the billing information is to be formed, when an instruction relating to the image forming job is received; and
an instruction section configured to instruct the image forming section to form the image of the billing information depending on a job relating to the received instruction, if the availability determination section determines that the image of the billing information is not to be formed,
wherein when the instruction from the instruction section is received, the image forming section forms the image of the billing information on the recording sheet.

2. The image forming system according to claim 1, wherein a primary job which requires the formation of the image of the billing information and a secondary job which does not require the formation of the image of the billing information are selectively performed,
at the time of performing the primary job, if the availability determination section determines that the image of the billing information is not to be formed, the image forming section forms the image of the billing information depending on the primary job, and
at the time of performing the secondary job, if the availability determination section determines that the image of the billing information is not to be formed, the image forming section performs the secondary job but the image of the billing information depending on the secondary job is not formed.

3. The image forming system according to claim 1, wherein the image forming apparatus includes recording sheets having a plurality of types of sizes,
the image forming apparatus includes a selection section configured to select a recording sheet having the smallest size among the plurality of types of sizes, if the availability determination section determines that the image of the billing information is not to be formed, and
the image forming section forms the image of the billing information on the recording sheet selected by the selection section.

4. The image forming system according to claim 1, wherein the recording sheet has a rectangular shape, and
the image forming section forms the image of the billing information on edges of the recording sheet.

5. The image forming system according to claim 1, further comprising:
a detection section configured to detect an absence of the specific recording sheet,
wherein if it is determines that the specific recording sheet is absent by the detection section, the availability determination section determines that the image of the billing information is not to be formed.

6. The image forming system according to claim 2, further comprising:
a notification section configured to notify a fact that the image of the billing information is not to be formed based on the determination of the availability determination section at the time of performing the secondary job; and
a continuance determination section configured to determine whether to continue to perform the secondary job.

7. An image forming system including an image forming apparatus which includes an image forming section receiving an instruction to perform an image forming job on a recording sheet and a billing apparatus forming an image of billing information on a specific recording sheet depending on the job, the image forming system comprising:
an availability determination means configured to determine whether the image of the billing information is to be formed, when an instruction relating to the image forming job is received; and
an instruction means configured to instruct the image forming section to form the image of the billing information depending on a job relating to the received instruction, if the availability determination means determines that the image of the billing information is not to be formed,
wherein when the instruction from the instruction means is received, the image forming section forms the image of the billing information on the recording sheet.

8. The image forming system according to claim 7, wherein a primary job which requires the formation of the image of the billing information and a secondary job which does not require the formation of the image of the billing information are selectively performed,
at the time of performing the primary job, if the availability determination means determines that the image of the billing information is not to be formed, the image forming section forms the image of the billing information depending on the primary job, and
at the time of performing the secondary job, if the availability determination means determines that the image of the billing information is not to be formed, the image forming section performs the secondary job but the image of the billing information depending on the secondary job is not formed.

9. The image forming system according to claim 7, wherein the image forming apparatus includes recording sheets having a plurality of types of sizes,
the image forming apparatus includes a selection means configured to select a recording sheet having the smallest size among the plurality of types of sizes, if the availability determination means determines that the image of the billing information is not to be formed, and
the image forming section forms the image of the billing information on the recording sheet selected by the selection means.

10. The image forming system according to claim 7, herein the recording sheet has a rectangular shape, and
the image forming section forms the image of the billing information on edges of the recording sheet.

11. The image forming system according to claim 7, further comprising:
a detection means configured to detect an absence of the specific recording sheet,
wherein if it is determines that the specific recording sheet is absent by the detection means, the availability determination means determines that the image of the billing information is not to be formed.

12. The image forming system according to claim 8, further comprising:
a notification means configured to notify a fact that the image of the billing information is not to be formed based on the determination of the availability determination means at the time of performing the secondary job; and
a continuance determination means configured to determine whether to continue to perform the secondary job.

13. An image forming method for forming an image of billing information, in an image forming system including an image forming apparatus which includes an image forming section receiving an instruction to perform an image forming job on a recording sheet and a billing apparatus forming the image of the billing information on a specific recording sheet depending on the job, the image forming method comprising:
a step of determining whether the image of the billing information is to be formed, when an instruction relating to the image forming job is received;
a step of instructing the image forming section to form the image of the billing information depending on a job relating to the received instruction, if it is determined that the image of the billing information is not to be formed in the determining step; and
a step of forming the image of the billing information on the recording sheet by the image forming section, when a instruction is received from the instructing step.

14. A non-transitory computer readable recording medium recorded with a computer program for forming an image of billing information, executable on a computer included in an image forming system including an image forming apparatus which includes an image forming section receiving an instruction to perform an image forming job on a recording sheet and a billing apparatus forming the image of the billing information on a specific recording sheet depending on the job, the computer program comprising:
a step of determining whether the image of the billing information is to be formed by the computer, when an instruction relating to the image forming job is received; and
a step of instructing the image forming section to form the image of the billing information depending on a job relating to the received instruction by the computer, if it is determined that the image of the billing information is not to be formed.
